(19) United States
(12) Patent Application Publication
(10) Pub. No.: US 2009/0220688 A1
(43) Pub. Date: Sep. 3, 2009

(54) DRYWALL TAPE AND JOINT COMPOUND DISPENSER

(75) Inventor: Ronald J. Morton, Sulphur Springs, OH (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Buddy Tools, LLC, Sulphur Springs, OH (US)

(21) Appl. No.: 12/466,051

(22) Filed: May 14, 2009

Related U.S. Application Data
(63) Continuation-in-part of application No. 11/190,298, filed on Jul. 27, 2005, now Pat. No. 7,537,037.

(51) Int. Cl. B05D 5/10; B44C 7/08; E04F 13/076

(52) U.S. Cl. 427/207.1; 156/575; 156/577; 156/71

(57) ABSTRACT

A dispenser for dispensing drywall tape and joint compound includes a first port configured to deposit the joint compound on a first region of the tape at a first thickness, and to deposit the joint compound on a second region of the tape at a second thickness, wherein the first thickness is greater than the second thickness.

### RELATED APPLICATION DATA

This application is a continuation-in-part of U.S. application Ser. No. 11/190,298 filed on Jul. 27, 2005, which is incorporated herein by reference in its entirety.

### FIELD OF THE INVENTION

The invention relates to a drywall or wallboard tape and joint compound dispenser and method. More specifically, the invention relates to a tool used in applying joint compound to drywall tape and a method for applying joint compound to drywall tape.

### BACKGROUND OF THE INVENTION

The joints formed between adjoining drywall or wallboard panels are generally covered with a lamination of joint compound and fibrous drywall tape to hide the cracks or seams defined by and between the abutting panels. Joint compound and tape are typically applied manually by trowel or by a pressurized hand-operated tape and compound applicator to lay down a thin layer of compound and tape over each joint. The compound is typically applied only to that side of the tape which faces the wallboard panel.

Once the initial layer or coat of joint compound and tape is applied, it is smoothed over with a tool, such as a taping knife or trowel, and allowed to dry overnight. A relatively narrow and thin coating of joint compound is subsequently applied over the initial lamination of joint compound and tape using a trowel or a pressurized joint compound applicator. This second operation covers the exposed or outer side of the drywall tape and sandwiches the tape between the first layer of joint compound and the newly applied layer.

This second layer of joint compound is then allowed to dry. After it dries, a third wider layer of joint compound is then applied over the second layer. Sanding is then required to smooth over the joint.

Numerous dispensers have been developed for applying a substance to a strip of material prior to application of the strip to another surface, including drywall joint compound dispensers which apply compound to the tape prior to application of the tape on the seams of wallboards. Examples of these prior art dispensers are shown in U.S. Pat. Nos. 3,496,909; 3,513,809; 3,381,661; 3,292,575; 4,067,294; 1,935,060; 2,717,575; 2,679,232; 2,779,307; and 4,159,695.

Although these known prior art dispensers serve their intended purposes, including providing solutions to many problems experienced in drywall installation, most of these dispensers are complicated devices which are expensive to manufacture and are time-consuming and expensive to maintain in proper working condition since they include moving parts subject to wear which ultimately require repair or replacement. Further, such dispensers typically are bulky and, thus, occupy significant space as they are stored and/or transported.

### SUMMARY OF THE INVENTION

The present invention provides a drywall tape dispenser and method that deposits drywall joint compound on tape as the tape is dispensed from the dispenser. More particularly, different regions of the tape are coated with joint compound having different thicknesses. This facilitates seam filling as the tape is applied to a seam (e.g., the extra joint compound is deposited on a region of the tape that covers the seam). Additionally, the present invention provides a drywall tape dispenser that can be stacked, wherein when stacked, the dispensers nest with one another so as to enable one to store multiple dispensers in a compact space. Further, the dispenser can be easily cleaned, and simple to manufacture.

According to one aspect of the invention, a dispenser for dispensing drywall tape and joint compound includes a first port configured to deposit the joint compound on a first region of the tape at a first thickness, and to deposit the joint compound on a second region of the tape at a second thickness, wherein the first thickness is greater than the second thickness. Preferably, the first region of the tape includes a longitudinal centerline of the tape, and the second region of the tape includes at least one edge of the tape that is parallel to the longitudinal centerline of the tape.

The port can be formed to have a hemispherical, triangular or step configuration. Additionally, the dispenser can include a first receptacle for holding the drywall joint compound, wherein the first port is formed in the first receptacle. The dispenser can also include a tape holder for holding the tape, and a second port formed in the first receptacle, the second port configured to receive tape from the tape holder.

According to another aspect of the invention, there is provided a stackable drywall tape and joint compound dispenser that includes a tape holder and a reservoir for storing drywall joint compound. The dispenser can be configured such that when the dispenser is placed on another dispenser of substantially the same configuration, at least one of the respective tape holders and/or reservoirs of each dispenser nest with one another.

Preferably, at least one of the tape holder and reservoir are tapered such that an upper region of the tape holder or reservoir is wider than a lower region the tape holder or reservoir. The tape holder and/or reservoir can be formed in a V-shape, such that an angle formed between a floor of the tape holder (and/or reservoir) and a wall of the respective tape holder (and/or reservoir) is obtuse.

More particularly, a configuration of the tape holder can be different from a configuration of the reservoir. Additionally, the tape holder and reservoir can be formed having rectilinear or curvilinear shapes.

Yet more particularly, the reservoir can include an input port for receiving drywall tape, and an output port for dispensing drywall tape coated with joint compound. At least one of the input port and the output port can be formed so as to inhibit leakage of joint compound from the reservoir. Leakage from the input port and/or output port can be inhibited by forming the respective ports to follow a contour of the reservoir.

More particularly, the dispenser can be a multi-piece dispenser or single piece dispenser. Further, the dispenser can be configured with no moving parts, and/or can include a channel that guides the drywall tape through a pre-determined path within the dispenser.

Yet more particularly, the dispenser can include a cutting edge, such as a sharp or serrated edge, for cutting the drywall tape. Further, the dispenser can include a selectively retractable platform coupled to the dispenser. The platform can be coupled to the dispenser via a hinge, such as a rotatable or elastic hinge, and the platform can be detachable from the dispenser.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed.

### BRIEF DESCRIPTION OF THE DRAWINGS

FIG. 1 is a perspective view of a drywall tape and joint compound dispenser in accordance with a first embodiment of the invention.

FIGS. 2A-2D are top, side, front and back views, respectively, of the dispenser of FIG. 1.

FIG. 3 is a sectional view of the dispenser of FIG. 1.

FIG. 4 is an exemplary shipping container that includes multiple dispensers, wherein the dispensers are stacked on one another in a nesting configuration.

FIGS. 5A and 5B illustrate an alternative tape holder in accordance with an embodiment of the invention.

FIGS. 6A-6C are top, side and back views of the base of the dispenser of FIG. 1.

FIG. 7 is a perspective view of a drywall tape and joint compound dispenser in accordance with a second embodiment of the invention.

FIGS. 8A-8D are top, side, front and back views, respectively, of the dispenser of FIG. 7.

FIG. 9 is a sectional view of the dispenser of FIG. 7.

FIG. 10 illustrates dispensers according to FIG. 7 stacked on one another in a nesting configuration.

FIG. 11 illustrates an alternative tape path into the reservoir in accordance with an embodiment of the invention.

FIGS. 12A-12B illustrate side and front views of a dispenser in accordance with another embodiment of the invention.

FIGS. 13A and 13B are sectional views of the dispenser of FIGS. 12A and 12B showing the platform in the retracted and extended position.

FIG. 14 illustrates dispensers according to FIG. 12A stacked on one another in a nesting configuration.

FIGS. 15A illustrates a front view of a dispenser having exemplary port for dispensing drywall tape and joint compound in accordance with an embodiment of the invention.

FIG. 15B illustrates a front and top view of drywall tape extracted from the port of FIG. 15A, wherein the tape is coated with joint compound.

FIG. 15C illustrates a front view of a dispenser having another exemplary port for dispensing drywall tape and joint compound in accordance with an embodiment of the invention.

FIG. 15D illustrates a front view of a dispenser having another exemplary port for dispensing drywall tape and joint compound in accordance with an embodiment of the invention.

FIG. 16 illustrates an exemplary relationship between an outer region and an inner region of drywall tape.

### DETAILED DESCRIPTION

In the detailed description that follows, corresponding components have been given the same reference numerals, regardless of whether they are shown in different embodiments of the present invention. To illustrate the present invention in a clear and concise manner, the drawings may not necessarily be to scale.

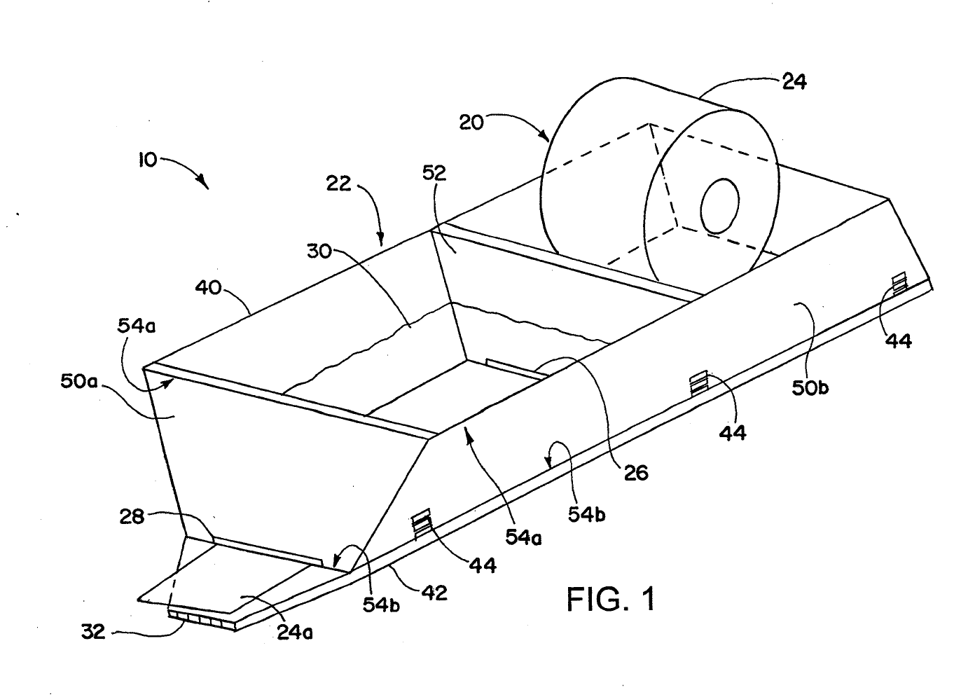

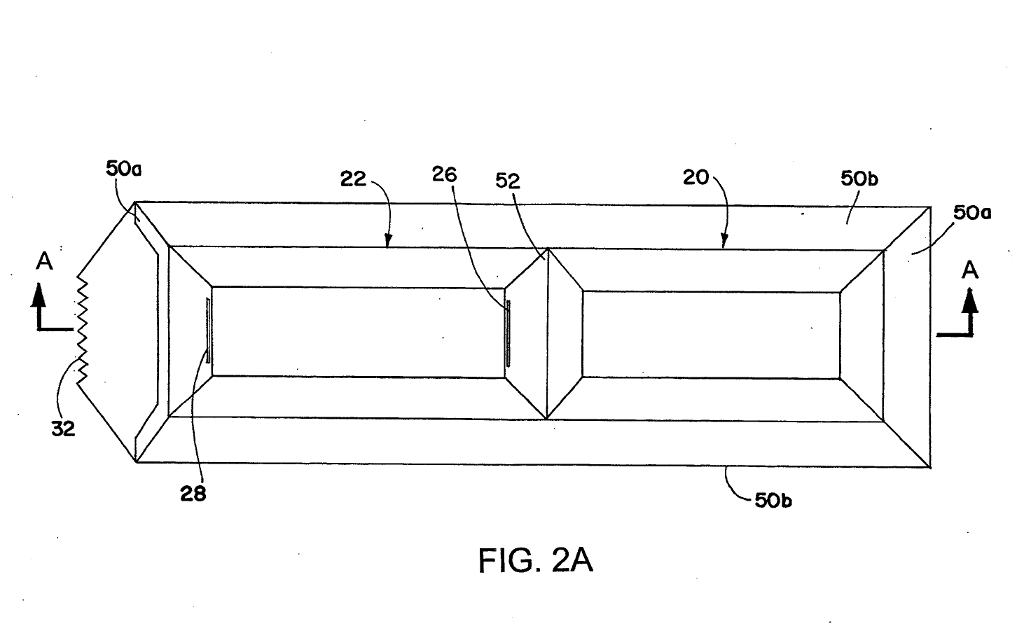

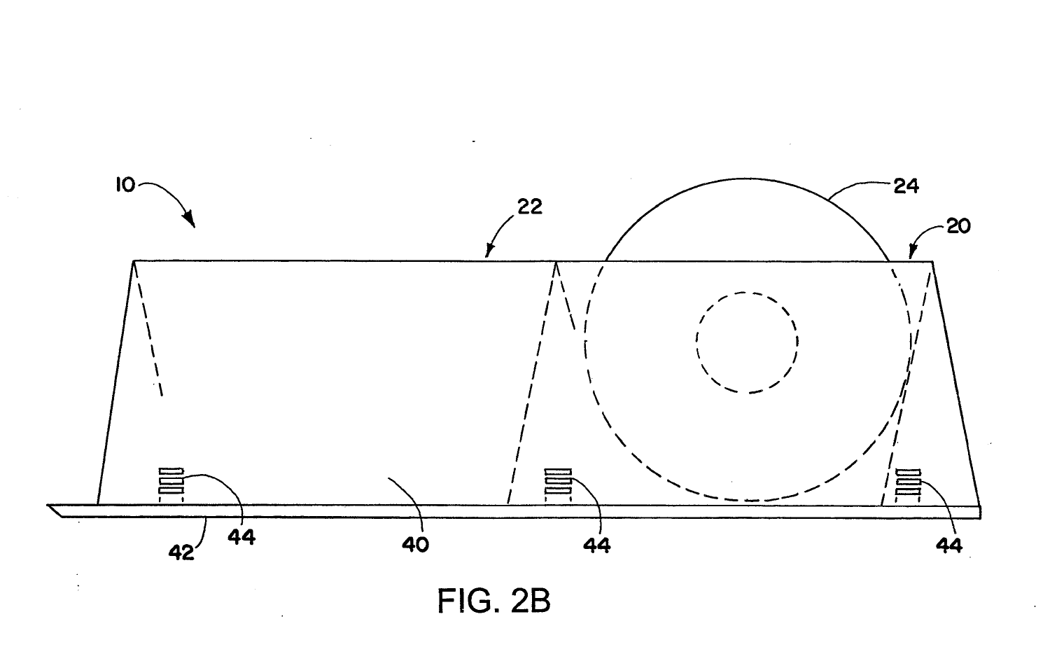

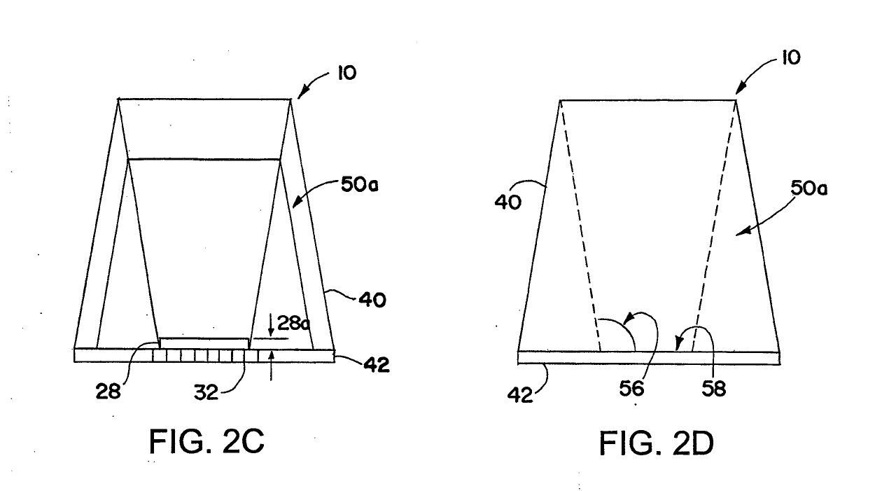

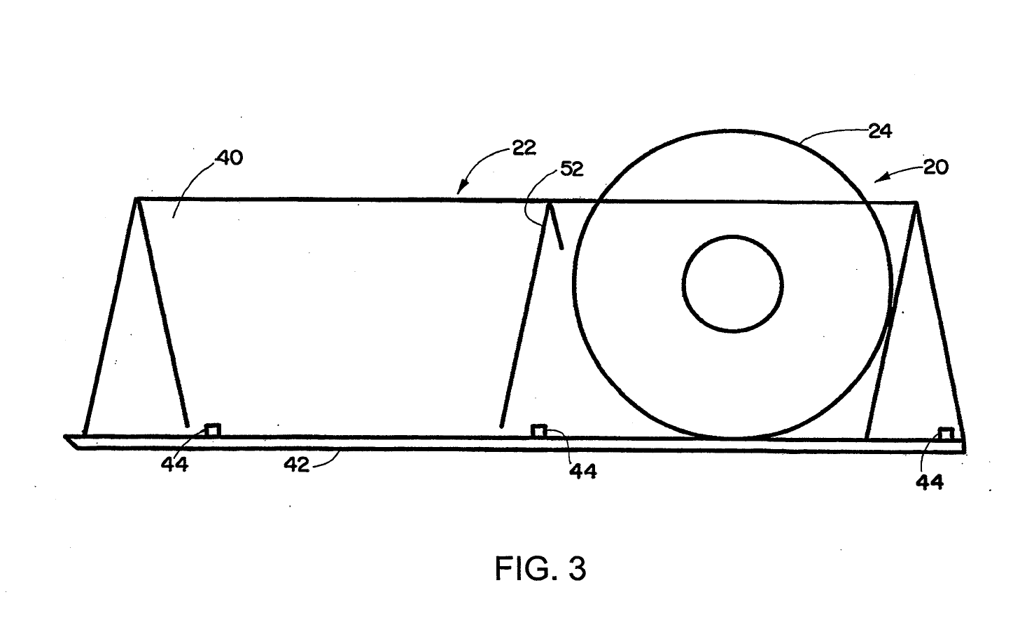

The present invention will now be described in conjunction with the drawings. Referring initially to FIG. 1, there is provided a perspective view of a drywall tape dispenser 10 in accordance with a first embodiment of the invention. FIGS. 2A-2D illustrate top, side, front and back views, respectively, of the dispenser 10, while FIG. 3 is a cross section of the dispenser 10 taken along section A-A

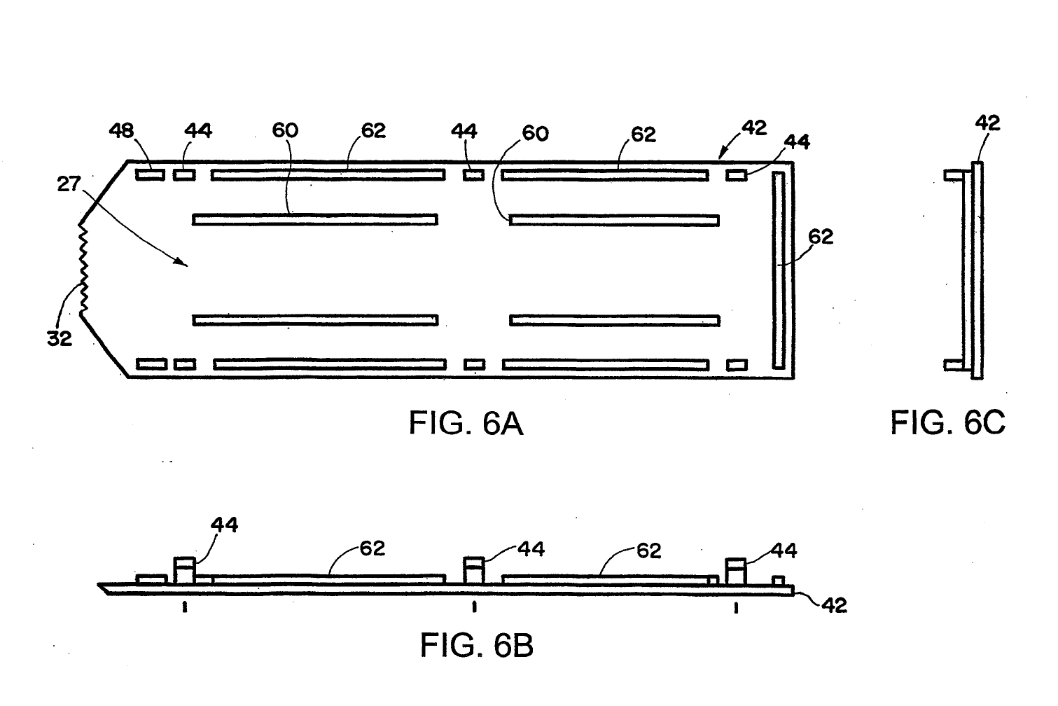

The dispenser 10 includes a tape holder 20 and a reservoir 22. Drywall tape 24, such as a roll of drywall tape, is placed in the tape holder 20 of the dispenser 10 and the tape is threaded through a first elongated guide slot 26, which, via a channel 27 (FIG. 6A), connects the tape holder 20 to the reservoir 22. The drywall tape 24 also is threaded through a second elongated guide slot 28, from which the drywall tape 24 exits the dispenser 10. Drywall joint compound or “mud” 30 having a desired consistency then is placed in the reservoir 22 at a level above the drywall tape 24, thereby covering the drywall tape 24.

As the drywall tape 24 is extracted from the dispenser 10, the tape 24, via the first elongated guide slot 26 and channel 27 (FIG. 6A), passes from the tape holder 20 into the mud filled reservoir 22, thereby becoming coated with a layer of mud 30. The tape 24 is extracted from the reservoir 22 via the second elongated guide slot 28 and can be cut as needed while leaving a free end of drywall tape 24a outside the dispenser 10. The free end 24a facilitates grasping and pulling more drywall tape 24 from the dispenser 10. A cutting edge 32, such as a sharp or serrated edge, for example, can be used to cut or tear the drywall tape 24 to a desired length. The mud coated tape 24 then can be applied to wallboard panels and, if necessary, the tape and compound can be flattened against each wallboard panel with a putty knife or trowel.

As used herein, a reservoir or receptacle is to be construed broadly, and includes a basin, a trough, a container, or the like, that can hold an object or substance in solid, semi-solid, or liquid form. A reservoir or receptacle, as used herein, is not limited to a long and narrow shape as shown in the figures, but can be any shape, including rectilinear shapes, e.g., a frustrum, a wedge, etc., and curvilinear shapes, e.g., a sphere segment, one half of a right circular cylinder, etc., that facilitates dispensing mud 30 and/or drywall tape 24.

The dispenser 10 can be a multi-piece unit having a body 40 and a detachable base 42. Selectively operable retainers 44, such as clips or the like, may hold the base 42 to the body 40. The selectively operable retainers 44 also allow the base 42 to be positioned in one of a plurality of different orientations with respect to the body 40. By adjusting the position of the base 42 with respect to the body, a height 28a of the second elongated slot 28 can also be adjusted. This is advantageous in that it permits an amount of mud 30 deposited on the extracted tape 24 to be set or controlled. If more mud is desired on the tape, the base 42, via the selectively operable retainers 44, can be adjusted to increase an overall height 28a of the second guide slot 28. Alternatively, if less mud 30 is desired on the extracted tape 24, the base 42 can be adjusted to decrease the overall height 28a of the second guide slot 28.

In another embodiment, the base 42 can have a tapered or sloped surface in the region of the elongated slot 28. The slope of the base 42 can be used to adjust the amount of mud deposited on the tape simply by positioning the base further forward or backward with respect to the body 40. For example, the slope can increase along the base 42, with a low portion being near the cutting edge 32 and a higher portion away from the cutting edge 32. If less mud is desired on the tape 24, the base 42 can be moved forward with respect to the body 40 such that the height 28a of the elongated slot 28 is reduced. Conversely, if additional mud is desired on the tape 24, the base 42 can be moved backward with respect to the body 40 such that the height 28a of the elongated slot 28 is increased. As will be appreciated, the base and/or body can be provided with a number of selectively operable retainers 44 at various locations such that the base 42 can be secured to the body 40 in any one of a number of locations.

Further, the detachable base 42 facilitates cleaning of the dispenser 10. Moreover, and as will be discussed in more detail below, once the base 42 is detached from the body 40, multiple bodies 40 can be stacked together such that the bodies 40 nest with one another. This is particularly advantageous for shipping and/or stocking the dispenser 10 in retail stores, as significantly less space is occupied when the bodies are nested. Multiple bases 42 also may be stacked on one another.

The body 40 includes end walls 50a and sidewalls 50b (collectively referred to as walls), which, in conjunction with a divider wall 52, define the walls of the tape holder 20 and the reservoir 22. The walls 50a, 50b and the divider wall 52 are tapered such that top regions 54a of the tape holder 20 and/or reservoir 22 are wider than bottom regions 54b of the tape holder and/or reservoir. For example, an angle 56 (FIG. 2D) formed between a floor 58 of the tape holder 22, e.g., the base 42 as the base is attached to the body 40, (or reservoir) and the walls of the tape holder (or reservoir) is obtuse, such that opposing walls form a V-shape. The taper facilitates nesting of multiple bodies 40, wherein as the bodies are stacked, walls 50a, 50b, 52 that define each tape holder and reservoir of the dispenser 10 nest with walls 50a, 50b, 52 that define the tape holder and reservoir of an adjacent dispenser 10. Referring briefly to FIG. 4, there is shown an exemplary shipping container 59 that includes a plurality of bodies 40 stacked on top of one another, wherein each body 40 nests with an adjacent body 40 as they are stacked. Also shown are a plurality of bases 42 stacked on one another.

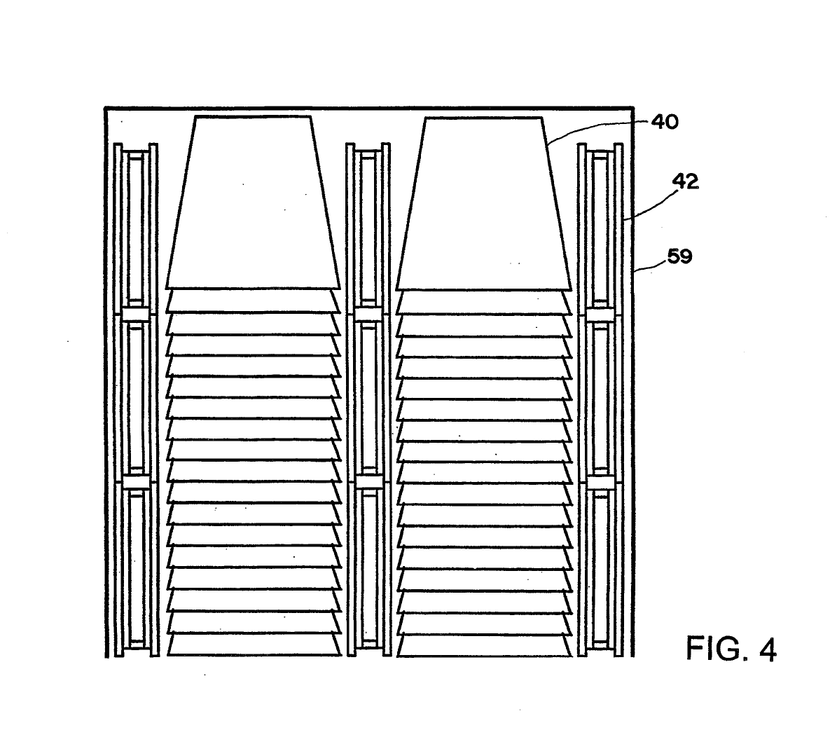

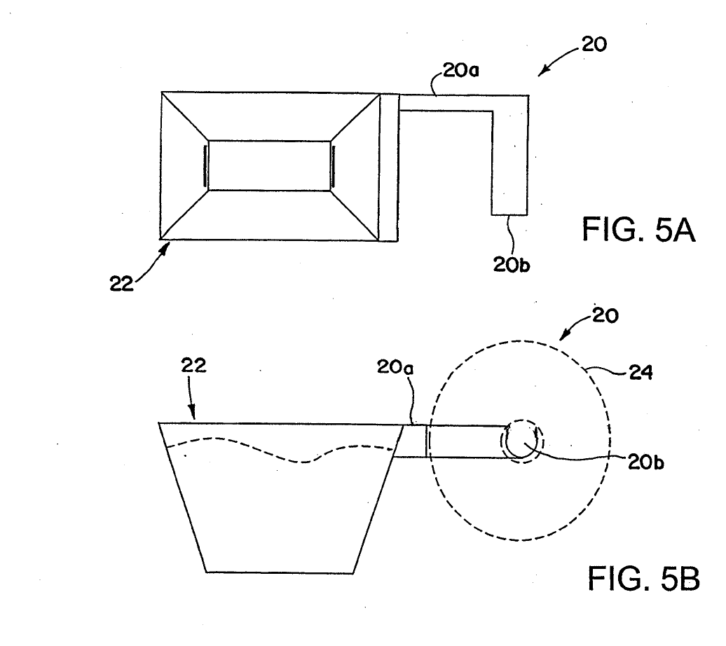

While the dispenser 10 is shown as having a tape holder 20 and reservoir 22 that are substantially equal in shape and size, it will be appreciated that the tape holder and reservoir may have different dimensions and/or different configurations from one another. For example, the reservoir 22 may be larger than the tape holder 20, thereby accommodating a larger volume of mud. Alternatively, the tape holder 20 may have a curvilinear shape, while the reservoir 22 may have a rectilinear shape. Further, the tape holder 20 may be formed having a structure significantly different from the reservoir 22. For example, and referring briefly to FIGS. 5A and 5B, the tape holder 20 can include an arm 20a having a spool or roll holder 20b for accepting the drywall tape 24. The arm 20a can be attached to the dispenser 10 via a hinge, swivel, or the like (not shown), such that the arm 20a can be moved to a location appropriate for storage and/or shipping. Alternatively, the arm 20a and spool holder 20b can be configured such that when two dispensers are stacked, the arm and spool holder of the respective dispensers nest within one another (e.g., the arm 20a can have a tapered configuration with an open top portion, and the spool holder 20b can be configured to have a semi-circular shape also with an open top portion).

With further reference to FIGS. 6A-6C, the base 42 can be a rectangular base (or any shape that conforms to a desired shape of the tape holder and/or reservoir) formed from metal, plastic, or other suitable materials. The base 42 can include elongated ridges 60 that form the channel 27, which tends to maintain the drywall tape 24 in a desired location. For example, the channel 27 can maintain the tape in a center region of the tape holder and reservoir as the tape is drawn through the dispenser 10. The base 42 can further include assembly guides 62, which facilitate alignment of the base 42 to the body 40 as the base and body are attached and/or detached from one another. The assembly guides 62 can be elongated segments that extend above a surface of the base 42 and interface with body 40 so as to guide and/or improve the rigidity of the overall dispenser 10.

Accordingly, a drywall tape dispenser according to the first embodiment of the present invention enables one to stack the dispenser bodies 40 such that the bodies nest with one another. Further, the base 42 can be easily removed from the body 40, thereby facilitating cleaning of the dispenser.

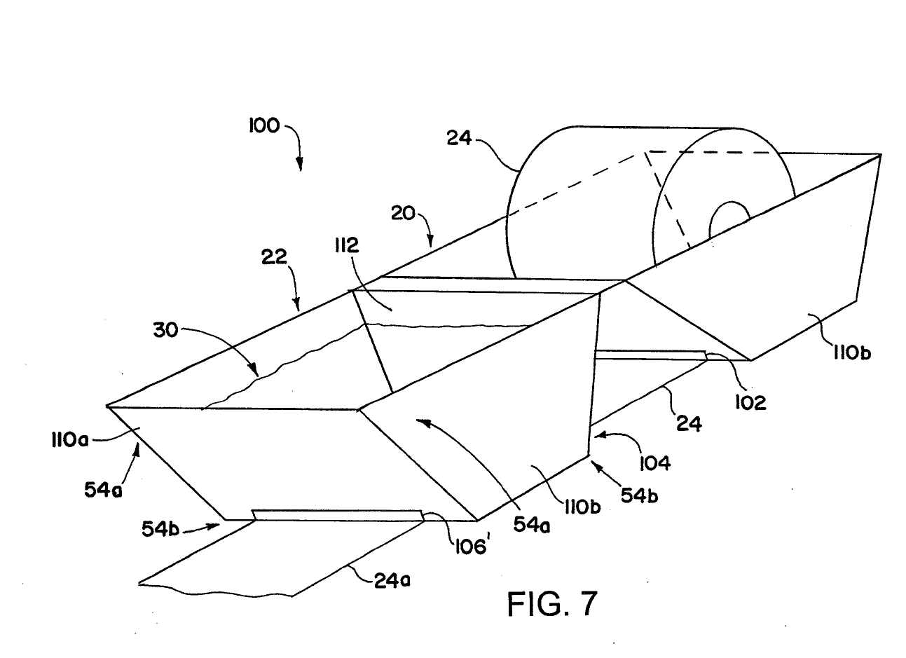

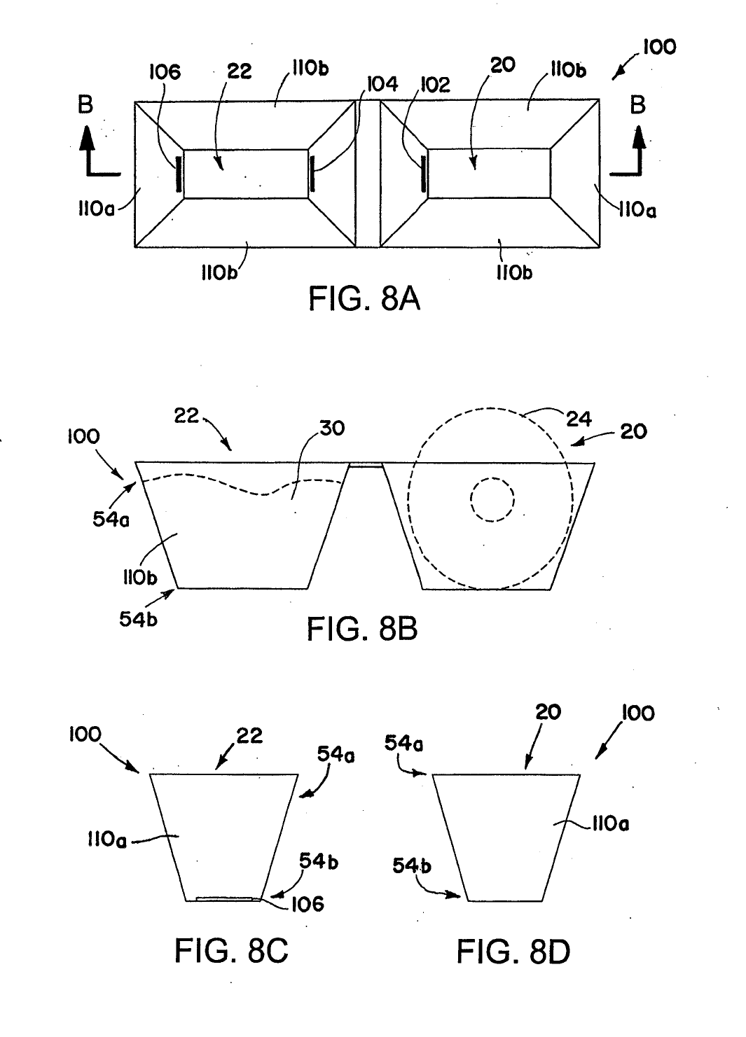

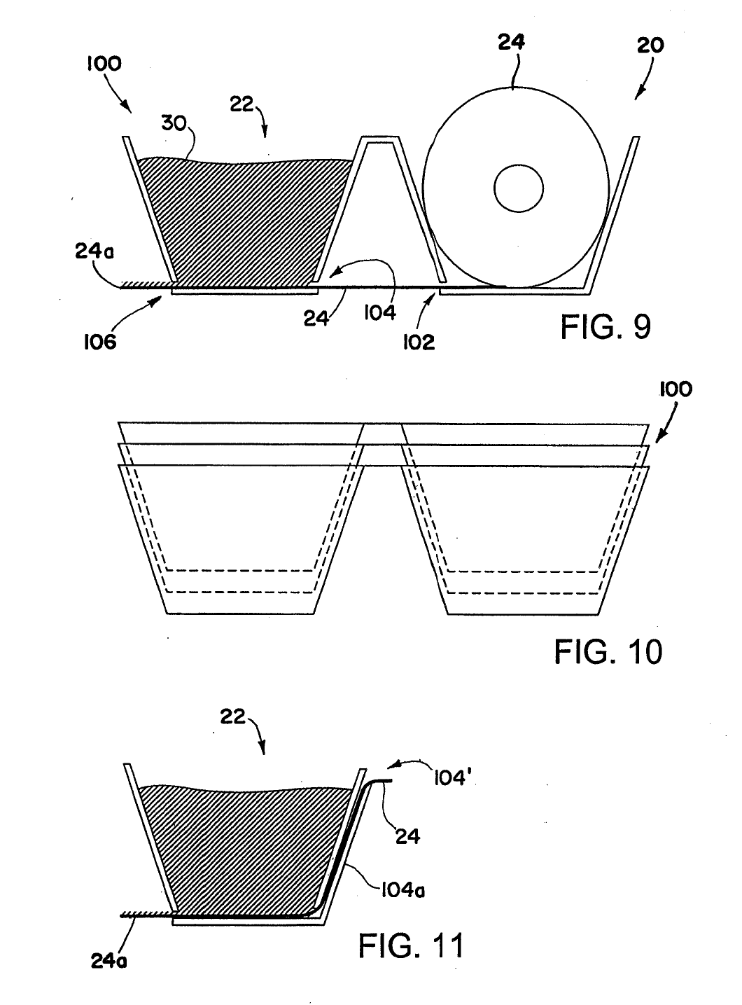

Referring now to FIG. 7, there is provided a perspective view of a dispenser 100 in accordance with a second embodiment of the invention. FIGS. 8A-8D illustrate top, side, front and back views, respectively, of the dispenser 100, while FIG. 9 illustrates a cross section of the dispenser taken along section B-B. The dispenser 100 is a one-piece unit having no detachable or moving parts, and includes a tape holder 20 and a reservoir 22. Drywall tape 24 is placed in the tape holder 20 and the tape is threaded through a first elongated guide slot 102, which guides the tape out of the tape holder 20. The drywall tape then is threaded into a second elongated guide slot 104, which guides the drywall tape 24 into the reservoir 22, and a third elongated guide slot 106, from which the drywall tape 24 exits the dispenser 100. Mud 30 having a desired consistency then can be placed in the reservoir 22 at a level above the drywall tape 24, thereby covering the drywall tape 24.

Like the previous embodiment, as the drywall tape 24 is extracted from the dispenser 100, the tape 24, via the first, second and third elongated guide slots 102, 104 106, passes from the tape holder 20 to the mud filled reservoir 22 and out of the dispenser 100, thereby becoming coated with a layer of mud 30. The coated drywall tape 24 can be torn or cut as needed while leaving a free end of drywall tape 24a outside the dispenser 100. This free end 24a then is available for grasping and pulling more drywall tape 24 from the dispenser 100 at a later time. The coated tape 24 then can be applied to wallboard panels as described previously.

The dispenser 100 includes end walls 110a and sidewalls 110b (collectively referred to as walls), which, in conjunction with a divider wall 112, define the walls of the tape holder 20 and the reservoir 22. The walls 110a, 110b, and the divider wall 112 are tapered such that top regions 54a of the tape holder 20 and reservoir 22 are wider than bottom regions 54b of the tape holder and reservoir. The wall taper facilitates nesting of multiple dispensers 100, wherein as the dispensers are stacked, the tape holder 22 and reservoir 20 of each dispenser 100 nest with the tape holder and reservoir of adjacent dispensers. Nesting of the dispensers 100 is illustrated in FIG. 10.

Depending on the consistency of the mud placed in the reservoir 22, it may be possible for some mud to “leak” from the second and third elongated slots 104, 106 of the dispenser 100. To minimize or prevent leakage from the respective slots 104, 106, the slots may include extensions that follow a contour of the reservoir 22, wherein an entry point (or exit point) for the elongated slot is placed at a level likely to be higher than a level of mud in the reservoir 22.

FIG. 11 illustrates this concept applied to the second elongated slot 104′. More specifically, the second elongated slot 104′ includes an extension 104a that follows the contour of the reservoir 22. Any mud that may leak into the second elongated slot 104′ will be contained by the extension 104a. To accommodate the alternative entry path to the second elongated slot 104′, the location of the first elongated slot 102 may be repositioned so as to provide a path to the second elongated slot that minimizes bending of the tape 24. For example, the first elongated slot 102 can be placed in an upper region of the tape holder 20 at substantially the same height as the second elongated slot 104′. Although not shown, it will be appreciated that the extension can be applied to the third elongated slot 106.

Accordingly, a drywall tape dispenser 100 according to the second embodiment of the invention can be formed as a one-piece unit and with no moving parts. Moreover, the dispenser 100 can be stacked one on top of another, wherein adjacent dispensers nest with one another.

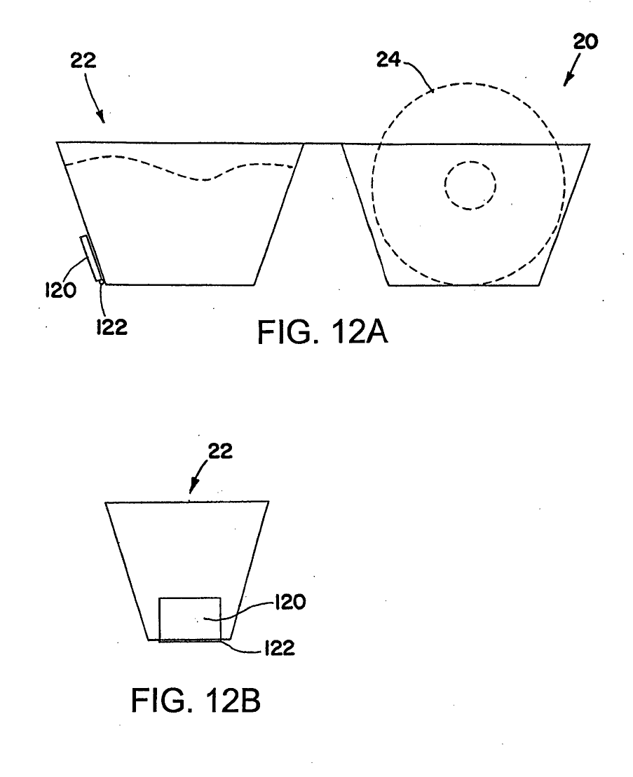

Referring now to FIGS. 12A-12B, a side view and a front view of a third embodiment of the dispenser 100′ in accordance with the present invention is illustrated. The dispenser 100′ is substantially the same as the dispenser 100 of FIGS. 7-11. However, the dispenser 100′ includes a retractable extension or platform 120 located at or near the third elongated slot 106. The platform 120 provides a surface for grasping or holding the tape 24 as the tape is cut or torn from the dispenser 100′. The platform 120 can be coupled to the dispenser 100′ via a rotatable hinge 122 or the like, such that the extension 120 may be placed in a retracted position or in an extended position. Alternatively, an elastic member, such as an elastic hinge or the like, may be utilized to attached the platform 120 to the dispenser 100′. Further, the platform 120 may be detachable from the dispenser, such that the platform 120 can be easily removed and attached from the dispenser 100′.

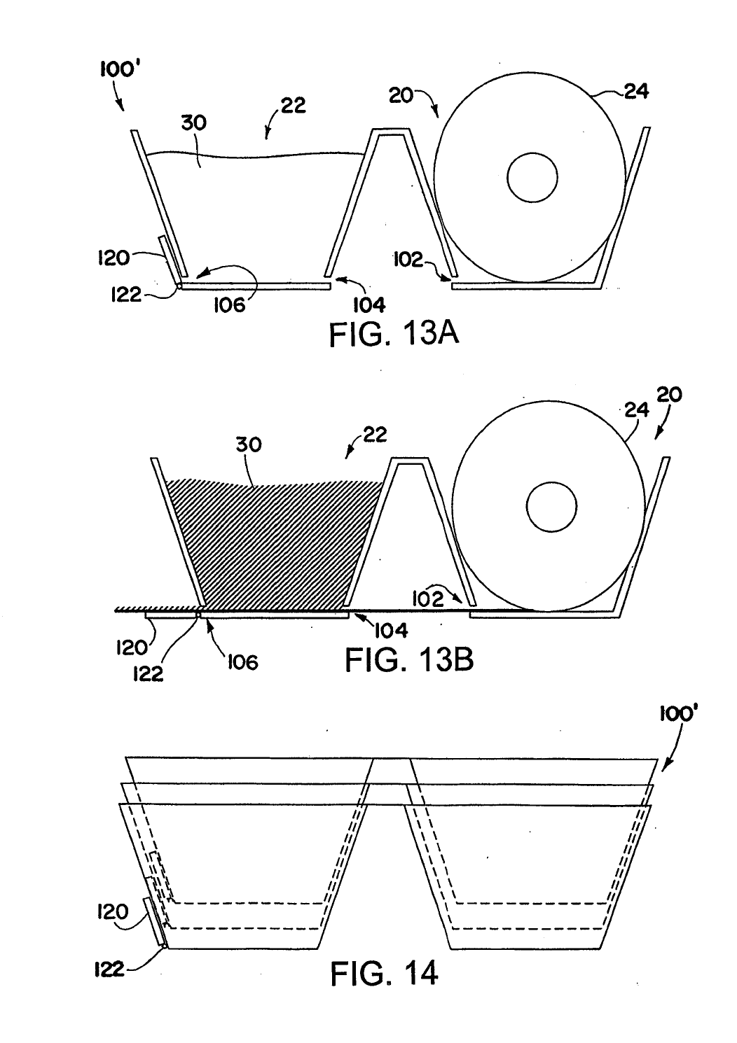

FIGS. 13A and 13B are cross sectional views of the dispenser 100′, illustrating the platform 120 in the retracted position (FIG. 13A) and the extended position (FIG. 13B). Typically, the platform 120 is in the retracted position when the dispensers 100′ are stacked in a nesting configuration, as shown in FIGS. 13A and 14, and in the extended position during normal use, as shown in FIG. 13B. The platform 120 can have any shape desired, although it is preferable that the shape of the platform does not inhibit the nesting feature of the dispenser 100′.

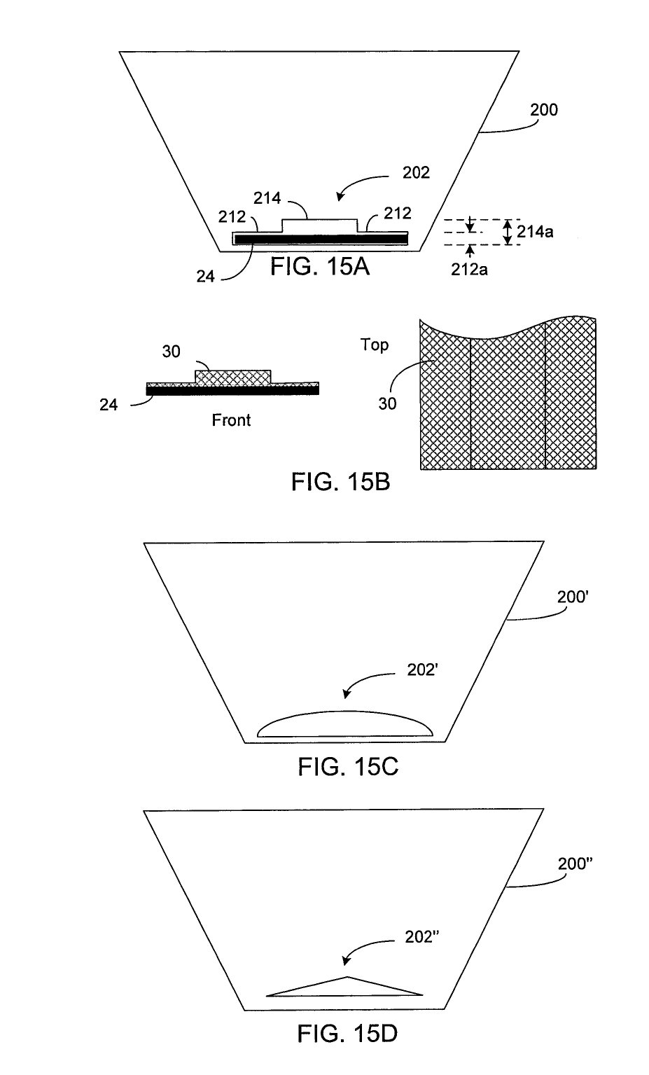

Moving now to FIG. 15A, there is shown a front view of a dispenser 200 having a guide slot 202 (also referred to as a port) in accordance with another aspect of the invention. With the exception of the guide slot 202, the dispenser 200 can be generally the same as the dispensers described herein and, thus, only guide slot 202 will be discussed.

The guide slot 202 provides a means for drywall tape 24 to be extracted from the dispenser 200, wherein as the tape 24 is extracted it passes through the first receptacle and is coated with a layer of joint compound 30 (e.g., the guide slot 202 functions as a portal from inside the reservoir 22 to outside the dispenser 200). The guide slot 202 is configured such that as drywall tape 24 is extracted, joint compound 30 is applied to the tape 24 at varying thicknesses. More particularly, the guide slot 202 is configured such that a thicker layer of joint compound 30 is applied to inner regions of the tape relative to outer regions of the tape. The additional joint compound 30 on the inner regions of the tape 24 is advantageous, for example, when placing the tape 24 over a seam, as the additional joint compound thoroughly fills gaps within the seam.

As used herein, an outer region of the tape refers to a region beginning at the longitudinal sides (e.g., outer longitudinal edges) of the tape and ending a predetermined distance from the longitudinal centerline of the tape. The inner region of the tape refers to a region that includes the longitudinal centerline of the tape and remaining portions of the tape not considered to be part of the outer region.

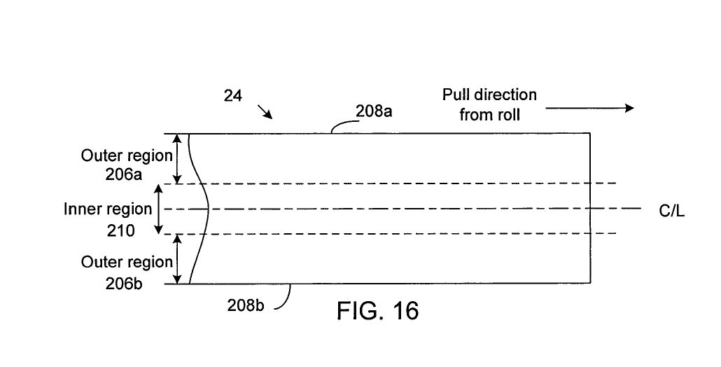

For example, and briefly referring to FIG. 16, if the tape 24 is 2 inches wide, each outer region 206a, 206b may be considered to begin at each longitudinal edge 208a, 208b, respectively, and extend inward about 0.66 inches from the outer edge. The inner region 210 may be considered to extend 0.33 inches from each side of the longitudinal centerline (C/L) of the tape (e.g., each region is one-third of the tape width).

It is noted that above relationship between the outer and inner regions is merely exemplary, and other relationships are possible without departing from the scope of the invention. For example, and again assuming drywall tape 24 that is 2 inches wide, each outer region may span ¼ inch, and the inner region may span 1.5 inches. As will be appreciated other dimensional relationships between the inner and outer regions are possible.

The exemplary guide slot 202 shown in FIG. 15A has a two-step configuration, wherein an outer region on each side of the guide slot 202 forms a first step 212 having a predetermined height 212a. A second step 214 also having a predetermined height 214a is formed on the inner region of the guide slot 202 (e.g., in a center region), wherein the height 214a of the second step is greater than the height 212a of the first step. Preferably, the first step has a height of about 0.1 inches, while the second step has a height of about 0.2 inches. In one embodiment, the height of the first and/or second step is adjustable. For example, one or more sliding members (not shown) may be formed on the outside of the dispenser 200 and arranged relative to the guide slot 202. The one or more sliding members can be configured to move relative to the guide slot 202 so as to vary the height 212a and 214a of the first and second steps 212 and 214.

Referring briefly to FIG. 15B, a front and top view of drywall tape 24 that has been extracted from the dispenser 200 is shown. As can be seen in FIG. 15B, the extracted tape 24 includes a layer of joint compound 30 that mirrors the step configuration of the guide slot 202.

Although a two-step configuration is shown in FIG. 15A, other configurations are possible. For example, the guide slot 202 can be configured to have three, four, or more steps. Alternatively, a dispenser 202′ can be configured to have a guide slot 202′ formed with a hemispherical shape or generally curved shape, as shown in FIG. 15C. Other shapes are also possible, (e.g., a dispenser 200″ having a guide slot 202″ with a triangular shape as shown in FIG. 15D), so long as tape dispensed from the guide slot has a thicker layer of joint compound on the inner regions of the tape relative to the outer regions of the tape.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A dispenser for dispensing drywall tape and joint compound, comprising a first port configured to deposit the joint compound on a first region of the tape at a first thickness, and to deposit the joint compound on a second region of the tape at a second thickness, wherein the first thickness is greater than the second thickness.

2. The dispenser according to claim 1, wherein the first region of the tape includes a longitudinal centerline of the tape.

3. The dispenser according to claim 2, wherein the second region of the tape includes at least one edge of the tape, said edge being parallel to the longitudinal centerline of the tape.

4. The dispenser according to claim 1, wherein the port comprises a hemispherical configuration.

5. The dispenser according to claim 1, wherein the port comprises a step configuration.

6. The dispenser according to claim 1, wherein the port comprises a triangular configuration.

7. The dispenser according to claim 1, further comprising a first receptacle for holding the drywall joint compound, wherein the first port is formed in the first receptacle.

8. The dispenser according to claim 7, further comprising:
a tape holder for holding the tape; and
a second port formed in the first receptacle, the second port configured to receive tape from the tape holder.

9. The dispenser according to claim 8, wherein when the dispenser is placed on another dispenser of substantially the same configuration, the respective tape holders and first receptacles nest within one another.

10. The dispenser according to claim 8, wherein a configuration of the tape holder is different from a configuration of the first receptacle.

11. The dispenser according to claim 8, wherein the tape holder comprises an arm coupled to the dispenser, said arm including a spool for accepting the tape.

12. The dispenser according to claim 8, further comprising a channel that guides the tape through a pre-determined path within the dispenser, the channel different from the port.

13. The dispenser according to claim 8, wherein the dispenser is a multi-piece dispenser comprising a body and a base, the base selectively couplable to the body.

14. The dispenser according to claim 8, wherein the first receptacle is formed integral with the tape holder.

15. The dispenser according to claim 8, wherein the tape holder comprises a second receptacle.

16. A method of applying drywall joint compound to drywall tape, comprising:
depositing the joint compound on a first region of the tape at a first thickness; and
depositing the joint compound on a second region of the tape at a second thickness, wherein the first thickness is greater than the second thickness.

17. The method according to claim 16, wherein depositing the joint compound on a first region of the tape includes depositing the joint compound on a longitudinal centerline of the tape.

18. The method according to claim 17, wherein depositing the joint compound on a second region of the tape includes depositing the joint compound on at least one edge of the tape, said edge formed parallel to the longitudinal centerline of the tape.

19. The method according to claim 16, wherein depositing the joint compound on the first and second regions includes depositing the joint compound to form a hemispherical shape over the first and second regions.

20. The method according to claim 16, wherein depositing the joint compound on the first and second regions includes depositing the joint compound to form a step configuration over the first and second regions.
